(19) United States
(12) Patent Application Publication
(10) Pub. No.: US 2020/0301200 A1
(43) Pub. Date: Sep. 24, 2020

(54) DISPLAY PANEL, MANUFACTURING METHOD THEREOF, AND DISPLAY DEVICE

(71) Applicant: BOE TECHNOLOGY GROUP CO., LTD., Beijing (CN)

(72) Inventor: Yunsik IM, Beijing (CN)

(21) Appl. No.: 16/646,633

(22) PCT Filed: Aug. 16, 2019
(86) PCT No.: PCT/CN2019/100962

§ 371 Date: Mar. 12, 2020

(30) Foreign Application Priority Data
Aug. 17, 2018 (CN) 201810942948.7

(51) Int. Cl. G02F 1/1335; G02F 1/1368; G02F 1/13357; G02F 1/1362

(52) U.S. Cl. CPC G02F 1/133528; G02F 1/1368; G02F 2001/133607; G02F 1/136209; G02F 2001/136222; G02F 1/133606

(57) ABSTRACT

The present disclosure provides a display panel, a manufacturing method thereof, and a display device. The display panel includes: a first substrate and a second substrate which are oppositely disposed, the first substrate including a plurality of sub-pixel regions arranged in an array; and a plurality of filtering polarization structures arranged in an array on the first substrate. The plurality of filtering polarization structures correspond to the plurality of sub-pixel regions one-to-one. Each filtering polarization structure is configured to transmit light having a first polarization direction and corresponding to a color of a sub-pixel region corresponding to the filtering polarization structure, and reflect light of other colors.

### RELATED APPLICATIONS

The present application is a 35 U.S.C. 371 national stage application of PCT International Application No. PCT/CN2019/100962, filed on Aug. 16, 2019, which claims the benefit of Chinese Patent Application No. 201810942948.7, filed on Aug. 17, 2018, the entire disclosures of which are incorporated herein by reference.

### TECHNICAL FIELD

Exemplary embodiments relate to the field of display technology, and in particular, to a display panel, a manufacturing method thereof, and a display device.

### BACKGROUND

Liquid crystal display device (LCD) is a type of flat panel display device. The liquid crystal display panel and the backlight module are important components of the liquid crystal display device. A liquid crystal display device is formed by setting a backlight source on a side of the liquid crystal display panel, thereby realizing image display.

The backlight module includes a backlight source, a light guide plate, and an optical film (for example, a reflective sheet, a diffusion sheet, a prism sheet, or a polarization increment film). The display panel includes: a liquid crystal cell, and two polarizers attached to both sides of the liquid crystal cell. During the work, natural light emitted by the backlight source passes through the optical film and is then directed to the polarizer near the backlight source. Linearly polarized light is formed after filtering of the polarizer. After the linearly polarized light passes through the liquid crystal cell, the polarization direction is changed. The linearly polarized light passes through the polarizer far away from the backlight source, thus presenting certain color and brightness.

Studies have found that the existing liquid crystal display devices have a low light utilization and it is difficult to achieve a high-brightness display effect.

### SUMMARY

In a first aspect, an exemplary embodiment provides a display panel. The display panel includes: a first substrate and a second substrate which are oppositely disposed, the first substrate including a plurality of sub-pixel regions arranged in an array; and a plurality of filtering polarization structures arranged in an array on the first substrate. The plurality of filtering polarization structures correspond to the plurality of sub-pixel regions one-to-one. Each filtering polarization structure is configured to transmit light having a first polarization direction and corresponding to a color of a sub-pixel region corresponding to the filtering polarization structure, and reflect light of other colors.

In some exemplary embodiments, each filtering polarization structure includes: a plurality of filtering polarization units arranged at intervals. Each filtering polarization unit includes: a first metal layer, a second metal layer, and a dielectric layer. The first metal layer is disposed on a side of a base substrate, the dielectric layer is disposed on a side of the first metal layer away from the base substrate, and the second metal layer is disposed on a side of the dielectric layer away from the base substrate. The orthographic projection of the first metal layer on the base substrate, the orthographic projection of the dielectric layer on the base substrate, and the orthographic projection of the second metal layer on the base substrate overlap.

In some exemplary embodiments, the distances between adjacent rows of filtering polarization structures are equal, and the distances between adjacent columns of filtering polarization structures are equal.

In some exemplary embodiments, in the same filtering polarization structure, the widths of the plurality of filtering polarization units are equal, and the distances between adjacent filtering polarization units are equal.

In some exemplary embodiments, a material of the first metal layer and the second metal layer includes aluminum or silver. A material of the dielectric layer includes silicon oxide or zinc selenide.

In some exemplary embodiments, the first substrate includes a base substrate and a thin film transistor array; the plurality of filtering polarization structures are disposed on a side of the base substrate away from the thin film transistor array; alternatively, the plurality of filtering polarization structures are disposed between the base substrate and the thin film transistor array; alternatively, the plurality of filtering polarization structures are disposed on a side of the thin film transistor array away from the base substrate.

In some exemplary embodiments, the display panel further includes a polarizer disposed on a side of the second substrate away from the first substrate. The polarizer is configured to transmit light having a second polarization direction; the first polarization direction is perpendicular or parallel to the second polarization direction.

In some exemplary embodiments, the first substrate is an array substrate, and the second substrate is a color film substrate.

In some exemplary embodiments, the color film substrate includes a plurality of color filters arranged at intervals and arranged in an array; a black matrix layer is provided between adjacent color filters; the plurality of color filters correspond to the plurality of filtering polarization structures one-to-one; an orthographic projection of each filtering polarization structure on the color film substrate is located within an orthographic projection of a corresponding color filter on the color film substrate.

Another exemplary embodiment provides a display device including a backlight module and the display panel according to above-mentioned embodiments.

In some exemplary embodiments, the backlight module includes a backlight source, a light guide plate, a diffusion sheet, and a prism sheet; the backlight source is on a light entrance side of the light guide plate; the diffusion sheet is on a light exit side of the light guide plate, and the prism sheet is on a light exit side of the diffusion sheet and provides light to the display panel.

Another exemplary embodiment provides a method for manufacturing the display panel according to above-mentioned embodiments. The method includes: forming a first substrate, the first substrate including a plurality of sub-pixel regions arranged in an array; forming a plurality of filtering polarization structures arranged in an array on the first substrate, the plurality of filtering polarization structures corresponding to the plurality of sub-pixel regions one-to-one; each filtering polarization structure being configured to transmit light having a first polarization direction and corresponding to a color of a sub-pixel region corresponding to the filtering polarization structure, and reflect light of other colors; forming a second substrate; and performing a cell aligning process on the first substrate and the second substrate.

In some exemplary embodiments, the step of forming the first substrate includes: providing a base substrate; and forming a thin film transistor array on a side of the base substrate facing the second substrate.

In some exemplary embodiments, the step of forming the plurality of filtering polarization structures arranged in an array on the first substrate includes: forming a first metal layer on a side of the base substrate away from the thin film transistor array; forming a dielectric layer on a side of the first metal layer away from the base substrate; and forming a second metal layer on a side of the dielectric layer away from the base substrate.

In some exemplary embodiments, the step of forming the plurality of filtering polarization structures arranged in an array on the first substrate includes: forming a first metal layer on a side of the base substrate facing the thin film transistor array; forming a dielectric layer on a side of the first metal layer away from the base substrate; and forming a second metal layer on a side of the dielectric layer away from the base substrate.

In some exemplary embodiments, the step of forming the plurality of filtering polarization structures arranged in an array on the first substrate includes: forming a first metal layer on a side of the thin film transistor array away from the base substrate; forming a dielectric layer on a side of the first metal layer away from the thin film transistor array; and forming a second metal layer on a side of the dielectric layer away from the thin film transistor array.

In some exemplary embodiments, the step of forming the second substrate includes: providing a polarizer on a side of the second substrate away from the first substrate. The polarizer is configured to transmit light having a second polarization direction; the first polarization direction is perpendicular or parallel to the second polarization direction.

In some exemplary embodiments, the step of forming the second substrate includes: forming a plurality of color filters and a black matrix on a side of the second substrate facing the first substrate. The plurality of color filters correspond to the plurality of filtering polarization structures one-to-one; an orthographic projection of each filtering polarization structure on the second substrate is located within an orthographic projection of a corresponding color filter on the second substrate.

### BRIEF DESCRIPTION OF THE DRAWINGS

The drawings are used to provide a further understanding of the technical solutions of the present disclosure, and constitute a part of the specification. The drawings are used to explain the technical solutions of the present disclosure together with the exemplary embodiments of the present application, and do not constitute a limitation to the technical solutions of the present disclosure.

FIG. 1 is a schematic structural diagram of a liquid crystal display device in the related art;

FIG. 2 is a schematic structural diagram of a display panel according to an exemplary embodiment;

FIG. 3 is a schematic structural diagram of a display panel according to another exemplary embodiment;

FIG. 4 is a schematic structural diagram of a filtering polarization structure according to an exemplary embodiment;

FIG. 5 is a schematic structural diagram of a display panel according to another exemplary embodiment;

FIG. 6 is a flowchart of a method for manufacturing a display panel according to an exemplary embodiment;

FIG. 7 is a schematic structural diagram of a display device provided by an exemplary embodiment;

FIG. 8 is a schematic structural diagram of a display panel according to another exemplary embodiment;

FIG. 9 is a schematic structural diagram of a display panel according to yet another exemplary embodiment; and

FIG. 10 is a schematic top view of the filtering polarization structure shown in FIG. 4.

### DETAILED DESCRIPTION OF THE DISCLOSURE

In order to make the objectives, technical solutions, and advantages of the present disclosure clear, exemplary embodiments will be described in detail below with reference to the accompanying drawings. It should be noted that, in the case of no conflict, the exemplary embodiments in the present application and the features in the embodiments can be arbitrarily combined with each other.

The steps shown in the flowchart of the drawings may be performed in a computer system with a set of computer-executable instructions. Though the logical order is shown in the flowchart, in some cases, the steps shown or described may be performed in a different order than here.

Unless otherwise defined, the technical terms or scientific terms disclosed in the exemplary embodiments shall have the ordinary meanings understood by those with ordinary skills in the field to which the present disclosure belongs. The terms “first”, “second”, and the like used in the embodiments of the present disclosure do not indicate any order, quantity, or importance, but are only used to distinguish different components. Words such as “including” or “comprising” mean that the element or item appearing before the words encompasses the element or item appearing after the words and its equivalent without excluding other elements or items. Words such as “connected” or “connection” are not limited to physical or mechanical connections, but may include electrical connections, whether direct or indirect. The words “up”, “down”, “left”, “right”, etc. are only used to indicate the relative position relationship. When the absolute position of the described object changes, the relative position relationship may also change accordingly.

FIG. 1 is a schematic structural diagram of a liquid crystal display device in the related art. As shown in FIG. 1, the liquid crystal display device includes a backlight module, an array substrate 120, a color film substrate 130, and a first polarizer 140. The backlight module includes a backlight source 111, a reflective sheet 112, a light guide plate 113, a diffusion sheet 114, a prism sheet 115, and a reflective polarizer 116. The transmission axis of the reflective polarizer 116 is consistent with the transmission axis of the first polarizer 140, and the color film substrate includes a color filter.

Specifically, unpolarized light emitted from the backlight source 111 passes through the light guide plate 113, the diffusion sheet 114, and the prism sheet 115. The reflective polarizer 116 transmits light having a polarization direction in accordance with the transmission axis of the first polarizer 140, and reflects light having a polarization direction inconsistent with the transmission axis of the first polarizer 140 to the light guide plate 113. The light passing through the reflective polarizer 116 is emitted through the first polarizer 140, the array substrate 120, and the color film substrate 130. The light emitted to the color film substrate 130 is white light. The color filter in the color film substrate in the liquid crystal display device provided in FIG. 1 transmits light corresponding to the color of the color filter and absorbs light of other colors. In addition, the reflective polarizer and the first polarizer also absorb part of the light, resulting in a low light utilization of the liquid crystal display device, thus a high-brightness display effect cannot be achieved.

In order to solve the above technical problems, exemplary embodiments provide a display panel, a manufacturing method thereof, and a display device, which are specifically described as follows.

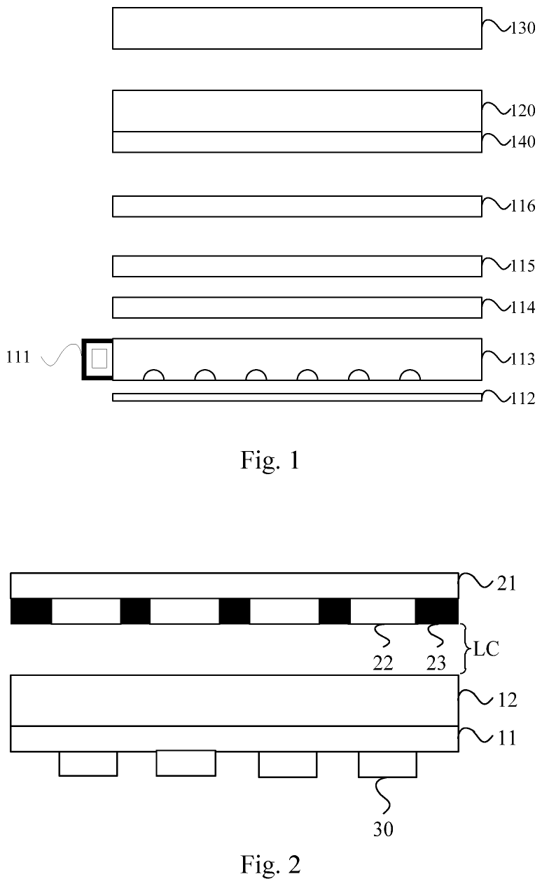

FIG. 2 is a schematic structural diagram of a display panel according to an exemplary embodiment. As shown in FIG. 2, a display panel provided by an exemplary embodiment includes: a first substrate and a second substrate which are oppositely disposed, the first substrate including a plurality of sub-pixel regions arranged in an array; and a plurality of filtering polarization structures 30 arranged in an array on the first substrate. The plurality of filtering polarization structures 30 correspond to the plurality of sub-pixel regions one-to-one. Each filtering polarization structure 30 is configured to transmit light having a first polarization direction and corresponding to a color of a sub-pixel region corresponding to the filtering polarization structure, and reflect light of other colors.

As shown in FIG. 2, the first substrate may include a base substrate 11 and a thin film transistor array 12, and the plurality of filtering polarization structures 30 may be disposed on a side of the base substrate 11 away from the thin film transistor array 12. The second substrate may include a glass substrate 21 and a plurality of color filters 22 arranged in an array. The plurality of color filters 22 are arranged at intervals on a side of the glass substrate 21 close to the first substrate, and a black matrix 23 is provided between adjacent color filters 22. The plurality of color filters 22 are in one-to-one correspondence with the plurality of sub-pixel regions of the first substrate, and each of the color filters 22 is configured to transmit light of a color corresponding to the corresponding sub-pixel region. Specifically, arranging the black matrix between adjacent color filters can prevent light leakage of the sub-pixels and ensure the display effect.

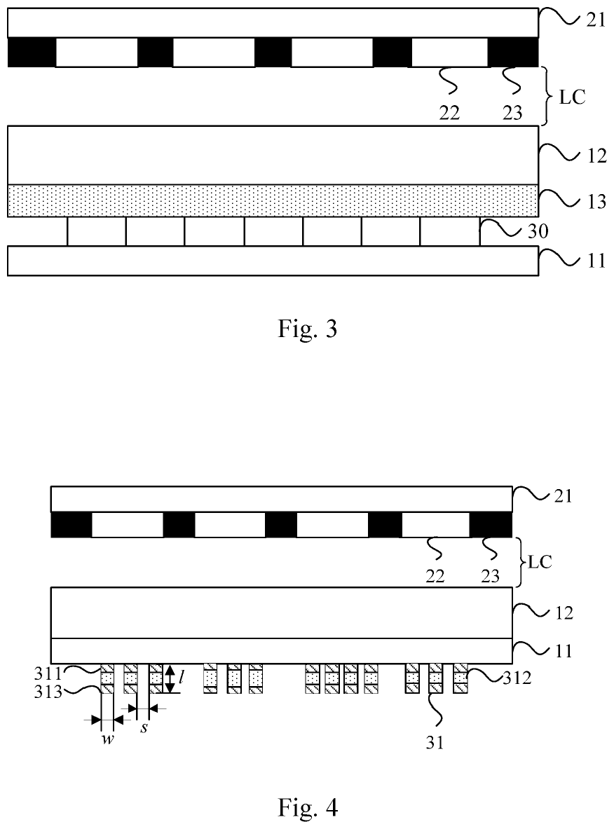

In some implementations, as shown in FIG. 3, the plurality of filtering polarization structures 30 may be disposed between the base substrate 11 and the thin film transistor array 12. An insulating layer 13 may be provided between the thin film transistor array 12 and the plurality of filtering polarization structures 30. The insulating layer 13 is used to to isolate the thin film transistor array and the filtering polarization structures. Optionally, the material for the insulating layer 13 may include: silicon oxide, silicon nitride, or a composite of silicon oxide and silicon nitride, which is not limited in the embodiments of the present disclosure.

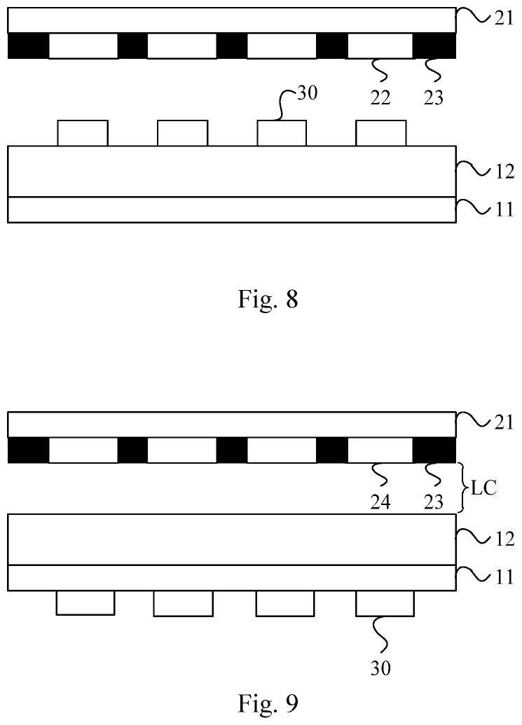

In some exemplary embodiments, as shown in FIG. 8, the plurality of filtering polarization structures 30 may be disposed on a side of the thin film transistor array 12 away from the base substrate 11. In this case, the filtering polarization structures can be set in the liquid crystal (LC) layer, which can effectively reduce the thickness of the display substrate and facilitate the production of ultra-thin display panels.

The light will be diffused to a certain extent during propagating from the filtering polarization structures to the color filter. In view of this, the size of the color filter may be slightly larger than the size of the corresponding filtering polarization structure, that is, an orthographic projection of a filtering polarization structure on the color film substrate is located within an orthographic projection of a corresponding color filter on the color film substrate. As shown in FIGS. 2, 3, and 8, in this way, the filtered and polarized light is not blocked by the black matrix, which improves the light utilization efficiency. Of course, the size of the color filter may also be smaller than or equal to the size of the corresponding filtering polarization structure, and the technical concept of the present invention may also be implemented. The disclosure does not limit the specific size of the color filter.

Optionally, the base substrate 11 may be a glass substrate, a quartz substrate, or other transparent substrate, which is not limited in the embodiments of the present disclosure. The thin film transistors in the thin film transistor array 12 may have a top gate structure or a bottom gate structure, which is not limited in the embodiment of the present disclosure.

Specifically, the one-to-one correspondence between the plurality of filtering polarization structures and the plurality of sub-pixel regions indicates that one filtering polarization structure is correspondingly provided on each sub-pixel region. The filtering polarization structure can also reflect light of other colors to the backlight module connected to the display panel (not shown in the drawing).

In some exemplary embodiments, a plurality of filtering polarization structures are provided on the first substrate to ensure that the light emitted by the filtering polarization structure is filtered light and does not include light of other colors. The color filter of the second substrate will directly transmits the filtered light without absorbing this part of light. The color filter on the second substrate only filters the light emitted from the position between adjacent filtering polarization structures, that is, the color filter on the second substrate only absorbs light of a color different from the color of the sub-pixel region and emitted from the position between adjacent filtering polarization structures. Therefore, in the technical solution provided in this application, the light absorbed by the color filter of the second substrate is less than that of the related art, improving the light utilization.

The display panel provided by exemplary embodiments includes: a first substrate and a second substrate which are oppositely disposed, the first substrate including a plurality of sub-pixel regions arranged in an array; and a plurality of filtering polarization structures arranged in an array on the first substrate. The plurality of filtering polarization structures correspond to the plurality of sub-pixel regions one-to-one. Each filtering polarization structure is configured to transmit light having a first polarization direction and corresponding to a color of a sub-pixel region corresponding to the filtering polarization structure, and reflect light of other colors. In the embodiment of the present disclosure, by applying the filtering polarization structure, light having the first polarization direction and corresponding to the color of the sub-pixel region corresponding to the filtering polarization structure can be transmitted, and light of other colors is reflected. That is, the polarizing function, the color filtering function and the reflecting function can be achieved by the same structure. Therefore, the number of optical films required for the display device is reduced, thereby reducing the absorption of light by the optical films. Moreover, it also ensures that the second substrate absorbs only a small amount of light, which further reduces the light absorption of the display panel, improves the utilization of light, and achieves a high-brightness display effect.

In the case where the second substrate includes a color filter, the second substrate may be a color filter substrate, and the first substrate is an array substrate.

When light emitted from a position between adjacent filtering polarization structures has a negligible effect on the display, the second substrate may include no color filters. FIG. 9 is a schematic structural diagram of a display panel according to another exemplary embodiment. As shown in FIG. 9, the second substrate includes: a glass substrate 21, a plurality of transparent dielectric layers 24 arranged at intervals and in an array on a side of the glass substrate 21 close to the first substrate, and a black matrix 23 arranged between adjacent transparent dielectric layers 24. In this way, the second substrate does not absorb light, which further improves the light utilization.

FIG. 4 is a schematic structural diagram of a filtering polarization structure provided by some exemplary embodiments. As shown in FIG. 4, each filtering polarization structure includes: a plurality of filtering polarization units 31 arranged at intervals. Each filtering polarization unit 31 includes: a first metal layer 311, a second metal layer 313, and a dielectric layer 312. The first metal layer 311 is disposed on a side of a base substrate 11, the dielectric layer 312 is disposed on a side of the first metal layer 311 away from the base substrate 11, and the second metal layer 313 is disposed on a side of the dielectric layer 312 away from the base substrate 11.

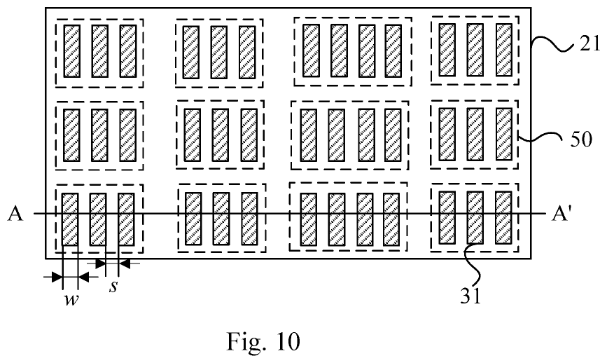

FIG. 10 shows a schematic top view of the filtering polarization structure shown in FIG. 4. In each sub-pixel region 50, a plurality of filtering polarization units 31 are sequentially arranged in parallel. FIG. 4 shows a cross-section of the filtering polarization structure shown in FIG. 10 taken along line A-A′.

In an exemplary embodiment, the material of the first metal layer 311 and the second metal layer 313 may be aluminum, and the thickness of the first metal layer 311 or the thickness of the second metal layer 313 may be 40 nm; the material of the dielectric layer 312 may be silicon oxide, and the thickness of the dielectric layer 312 may be 100 nm. For a filtering polarization structure corresponding to a red sub-pixel region, the width w of the filtering polarization unit 31 may be 185 nm, and the distance s between adjacent filtering polarization units may be 370 nm. For a filtering polarization structure corresponding to a green sub-pixel region, the width w of the filtering polarization unit 31 may be 120 nm, and the distance s between adjacent filtering polarization units may be 240 nm. For a filtering polarization structure corresponding to a blue sub-pixel region, the width w of the filtering polarization unit 31 may be 105 nm, and the distance s between adjacent filtering polarization units may be 210 nm.

In some exemplary embodiments, each filtering polarization structure includes a plurality of three-layer structured filtering polarization units. Each three-layer structured filtering polarization unit forms a type of FP (Fabry-Perot) cavity. It can be known from the FP cavity model that changes in the thickness of the first metal layer, the second metal layer, and the dielectric layer cause changes in the FP cavity, which will cause a change of the transmission peak position or reflection peak position for the FP cavity, so that selection of the transmission spectrum can be achieved, realizing the color filtering function.

In each filtering polarization structure, a plurality of filtering polarization units are arranged in parallel and spaced apart in sequence, and the metal layers (the first metal layer and/or the second metal layer) of the plurality of filtering polarization units substantially constitute a wire grid polarizer. If the polarization direction of the incident light is parallel to the length direction of the metal layer, the free electrons in the metal layer will be directed along the metal layer by the external electric field. Since the length of the metal layer is relatively long compared to the wavelength of the incident light, it is equivalent to the incident light acting on the surface of a metal thin film, that is, light with a polarization direction consistent with the length direction of the metal layer will be reflected. On the contrary, when the polarization direction of the incident light is perpendicular to the length direction of the metal layer, since the width of the metal layer is only about one-third to one-fourth of the wavelength of the incident light, the motion of the free electrons is severely restricted and the free electrons cannot be effectively interacted with the incident light, so that no reflected/refracted waves are generated. That is, light with such a polarization direction will be transmitted. Therefore, by adjusting the width of the filtering polarization unit, the distance between adjacent filtering polarization units, and the thickness of the metal layer(s), the selection of polarization can be achieved.

Optionally, the number of the filtering polarization units in the filtering polarization structure corresponding to the sub-pixel region of a certain color may be changed, and is determined according to actual requirements, which is not specifically limited in exemplary embodiments.

Specifically, when the filtering polarization structure is disposed on a side of the base substrate 11 away from the thin film transistor array 12, the first metal layer 311 may be disposed on a side of the base substrate 11 away from the thin film transistor array 12. When the filtering polarization structure is disposed between the base substrate and the thin film transistor array, the first metal layer may be disposed on a side of the base substrate near the thin film transistor array. When the filtering polarization structure is disposed on a side of the thin film transistor array away from the base substrate, the first metal layer may be disposed on a side of the thin film transistor array away from the base substrate. FIG. 4 illustrates that the first metal layer 311 is disposed on a side of the base substrate 11 away from the thin film transistor array 12.

Specifically, the orthographic projection of the first metal layer 311 on the base substrate 11, the orthographic projection of the dielectric layer 312 on the base substrate 11, and the orthographic projection of the second metal layer 313 on the base substrate 11 overlap.

Specifically, the distances between adjacent rows of filtering polarization structures are equal, and the distances between adjacent columns of filtering polarization structures are equal.

Specifically, in the same filtering polarization structure, the widths w of the plurality of filtering polarization units are equal, and the distances s between adjacent filtering polarization units are equal.

In exemplary embodiments, the filtering polarization structure including the plurality of filtering polarization units is substantially equivalent to a wire grid polarizer. By adjusting the width of the filtering polarization unit and the distance between adjacent filtering polarization units, the polarizing function can be realized. Each filtering polarization unit is equivalent to an FP resonant cavity. By adjusting the thickness/of the dielectric layer, the color filtering function can be realized. These parameters are not specifically limited in exemplary embodiments, as long as the color filtering function and the polarizing function can be achieved simultaneously.

In some exemplary embodiments, the material of the dielectric layer 312 includes silicon oxide or zinc selenide, which is not limited in the exemplary embodiments. It should be noted that for achieving the same function, the thickness of silicon oxide in the filtering polarization structure may be different from the thickness of zinc selenide in the filtering polarization structure, which may be determined according to actual needs.

In some exemplary embodiments, the material of the first metal layer 311 or the second metal layer 313 includes aluminum or silver. It should be noted that the material of the first metal layer 311 may be the same to the material of the second metal layer 313.

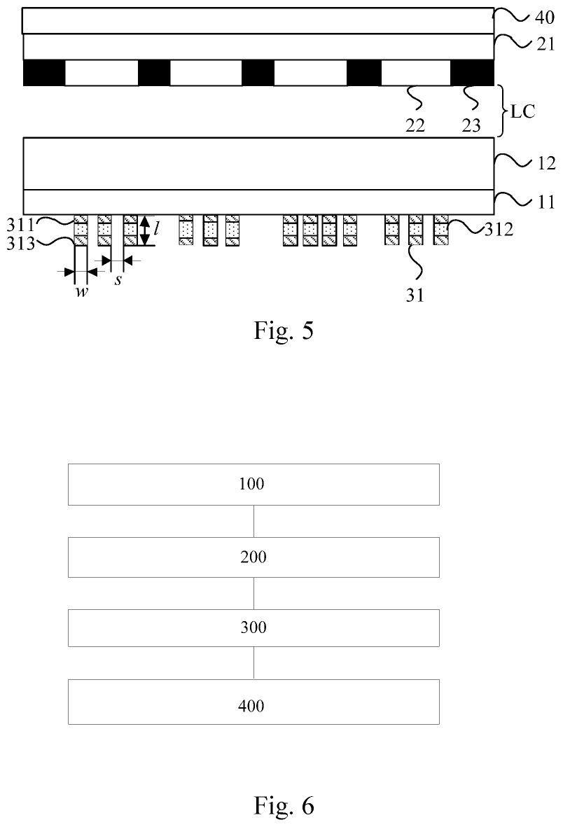

In some exemplary embodiments, in order to ensure that the display panel can display normally, the display panel provided in the embodiment of the present disclosure may further include a polarizer. FIG. 5 is a schematic structural diagram of a display panel provided by another exemplary embodiment. As shown in FIG. 5, the display panel provided by the embodiment of the present disclosure further includes a polarizer 40 disposed on a side of the second substrate away from the first substrate. The polarizer 40 is configured to transmit light having a second polarization direction; the first polarization direction is perpendicular or parallel to the second polarization direction.

In addition, it should be noted that the filtering polarization structure provided by the exemplary embodiment has the polarizing function of the polarizer provided on the first substrate in the related art, and can cooperate with the polarizer provided on the second substrate to ensure the normal operation of the display panel.

It should be noted that the liquid crystal display panel in some exemplary embodiments may be a liquid crystal display panel of any display mode, such as a twisted nematic (TN) liquid crystal display panel, an in-plane switching (IPS) liquid crystal display panel, a fringe field switching (FFS) liquid crystal display panel, a vertical alignment (VA) liquid crystal display panel, and an advanced super dimension switch (ADS) liquid crystal display panel. The embodiments of the present disclosure are not limited thereto.

An exemplary embodiment further provides a method for manufacturing the display panel provided by the foregoing exemplary embodiments. FIG. 6 is a flowchart of the method provided by some exemplary embodiments. As shown in FIG. 6, the method for manufacturing the display panel provided by the exemplary embodiment includes the following steps.

Step 100: forming a first substrate, the first substrate including a plurality of sub-pixel regions arranged in an array.

Step 200: forming a plurality of filtering polarization structures arranged in an array on the first substrate, the plurality of filtering polarization structures corresponding to the plurality of sub-pixel regions one-to-one; each filtering polarization structure being configured to transmit light having a first polarization direction and corresponding to a color of a sub-pixel region corresponding to the filtering polarization structure, and reflect light of other colors.

Step 300: forming a second substrate.

Step 400: performing a cell aligning process on the first substrate and the second substrate.

In some exemplary embodiments, the step of forming the first substrate includes: providing a base substrate; and forming a thin film transistor array on a side of the base substrate facing the second substrate. The base substrate may be a glass substrate, a quartz substrate, or other transparent substrate, which is not limited in the exemplary embodiments. The thin film transistors in the thin film transistor array may have a top gate structure or a bottom gate structure, which is not limited in the exemplary embodiments.

In some exemplary embodiments, the step of forming the plurality of filtering polarization structures arranged in an array on the first substrate includes: forming a first metal layer on a side of the base substrate away from the thin film transistor array; forming a dielectric layer on a side of the first metal layer away from the base substrate; and forming a second metal layer on a side of the dielectric layer away from the base substrate.

In some exemplary embodiments, the step of forming the plurality of filtering polarization structures arranged in an array on the first substrate includes: forming a first metal layer on a side of the base substrate facing the thin film transistor array; forming a dielectric layer on a side of the first metal layer away from the base substrate; and forming a second metal layer on a side of the dielectric layer away from the base substrate.

In some exemplary embodiments, the step of forming the plurality of filtering polarization structures arranged in an array on the first substrate includes: forming a first metal layer on a side of the thin film transistor array away from the base substrate; forming a dielectric layer on a side of the first metal layer away from the thin film transistor array; and forming a second metal layer on a side of the dielectric layer away from the thin film transistor array.

In some exemplary embodiments, the step of forming the second substrate includes: providing a polarizer on a side of the second substrate away from the first substrate. The polarizer is configured to transmit light having a second polarization direction; the first polarization direction is perpendicular or parallel to the second polarization direction.

In some exemplary embodiments, the step of forming the second substrate includes: forming a plurality of color filters and a black matrix on a side of the second substrate facing the first substrate. The plurality of color filters correspond to the plurality of filtering polarization structures one-to-one; an orthographic projection of each filtering polarization structure on the second substrate is located within an orthographic projection of a corresponding color filter on the second substrate.

According to some exemplary embodiments, the method for manufacturing the display panel includes: forming a first substrate, the first substrate including a plurality of sub-pixel regions arranged in an array; forming a plurality of filtering polarization structures arranged in an array on the first substrate, the plurality of filtering polarization structures corresponding to the plurality of sub-pixel regions one-to-one; each filtering polarization structure being configured to transmit light having a first polarization direction and corresponding to a color of a sub-pixel region corresponding to the filtering polarization structure, and reflect light of other colors; forming a second substrate; and performing a cell aligning process on the first substrate and the second substrate. In the exemplary embodiment of the present disclosure, by applying the filtering polarization structure, light having the first polarization direction and corresponding to the color of the sub-pixel region corresponding to the filtering polarization structure can be transmitted, and light of other colors is reflected. That is, the polarizing function, the color filtering function and the reflecting function can be achieved by the same structure. Therefore, the number of optical films required for the display device is reduced, thereby reducing the absorption of light by the optical films. Moreover, it also ensures that the second substrate absorbs only a small amount of light, which further reduces the light absorption of the display panel, improves the utilization of light, and achieves a high-brightness display effect.

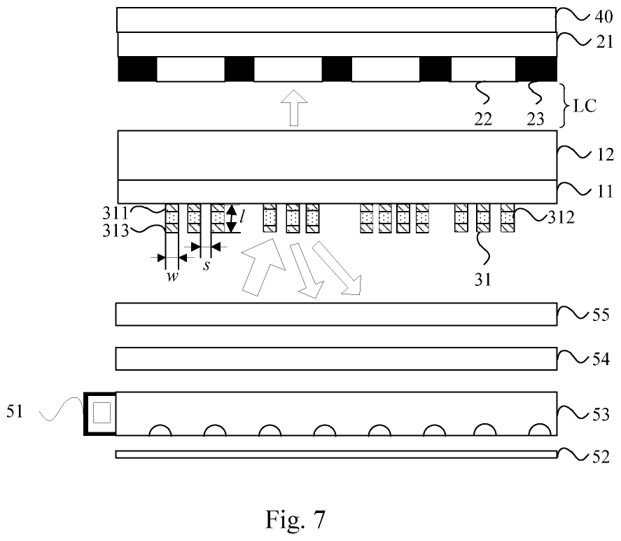

Based on the concepts of the foregoing exemplary embodiments, an exemplary embodiment further provides a display device. FIG. 7 is a schematic structural diagram of a display device provided by an exemplary embodiment. As shown in FIG. 7, the display device includes a backlight module and the display panel provided by the foregoing exemplary embodiments.

The display panel may be disposed on a light exit side of the backlight module.

Specifically, the display device is a liquid crystal display device. Optionally, the display device may be any product or component having a display function, such as a mobile phone, a tablet computer, a television, a display, a notebook computer, a digital photo frame, a navigator, and the like.

In some exemplary embodiments, the backlight module provided in the embodiment of the present disclosure is used to provide backlight for the display panel, and the light-emitting effect of the backlight source directly affects the display effect of the display device. It should be noted that the backlight module may be a lateral entrance type backlight module or a direct type backlight module, and exemplary embodiments are not limited thereto. FIG. 7 illustrates a lateral entrance type backlight module as an example.

As shown in FIG. 7, the backlight module provided by an exemplary embodiment includes a backlight source 51, a reflective sheet 52, a light guide plate 53, a diffusion sheet 54, and a prism sheet 55.

The backlight source 51 is disposed on the light entrance side of the light guide plate 53 and is configured to provide incident light. The light entrance side of the light guide plate 53 may be a lateral surface, or may be a surface of the light guide plate away from the diffusion sheet.

In some exemplary embodiments, the backlight source 51 includes a light emitting diode (LED) or a cold cathode fluorescent lamp (CCFL). The reflective sheet 52 is disposed on a side of the light guide plate 53 away from the diffusion sheet 54 and is used for reusing part of the light reflected from the display panel, reducing light loss and improving light utilization.

The light guide plate 53 is configured to guide light emitted from the backlight source 51.

The diffusion sheet 54 is disposed on the light exit side of the light guide plate 53 and diffuses light emitted from the light guide plate to provide uniform light.

The prism sheet 55 is disposed on the light exit side of the diffusion sheet 54 and is used to converge the light diffused by the diffusion sheet, increase the brightness, and provide incident light to the display panel.

Compared with the related art, the backlight module in the display device provided by exemplary embodiments removes reflective polarizers and reduces the number of the optical films, thereby reducing the absorption of light by the optical films, improving the light utilization, and achieving a high-brightness display effect.

The drawings of the exemplary embodiments only relate to the structures involved in the exemplary embodiments, and other structures of the display panel may refer to the design of the related art.

Some exemplary embodiments disclose a display panel, a manufacturing method thereof, and a display device. The display panel includes: a first substrate and a second substrate which are oppositely disposed, the first substrate including a plurality of sub-pixel regions arranged in an array; and a plurality of filtering polarization structures arranged in an array on the first substrate. The plurality of filtering polarization structures correspond to the plurality of sub-pixel regions one-to-one. Each filtering polarization structure is configured to transmit light having a first polarization direction and corresponding to a color of a sub-pixel region corresponding to the filtering polarization structure, and reflect light of other colors. In some exemplary embodiments, by applying the filtering polarization structure, light having the first polarization direction and corresponding to the color of the sub-pixel region corresponding to the filtering polarization structure can be transmitted, and light of other colors is reflected. The filtering polarization structure reduces the light absorption of the display panel, improves the utilization of light, and achieves a high-brightness display effect.

For clarity, in the drawings used to describe exemplary embodiments, the thickness and size of the layer or microstructure are exaggerated. It will be understood that when an element such as a layer, film, region, or substrate is referred to as being “on” or “under” another element, it can be “on” or “under” another element directly, or there may be intermediate elements.

Without conflict, exemplary embodiments of the present disclosure and the features in the exemplary embodiments can be combined with each other to obtain other embodiments.

The above exemplary embodiments are only used for explanations rather than limitations to the present disclosure. The ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A display panel, comprising:
a first substrate and a second substrate which are oppositely disposed, the first substrate comprising: a plurality of sub-pixel regions arranged in an array; and
a plurality of filtering polarization structures arranged in an array on the first substrate; the plurality of filtering polarization structures corresponding to the plurality of sub-pixel regions one-to-one;
wherein each filtering polarization structure is configured to transmit light having a first polarization direction and corresponding to a color of a sub-pixel region corresponding to the filtering polarization structure, and reflect light of other colors.

2. The display panel according to claim 1, wherein each filtering polarization structure comprises: a plurality of filtering polarization units arranged at intervals;
wherein each filtering polarization unit comprises: a first metal layer, a second metal layer, and a dielectric layer;
wherein the first metal layer is disposed on a side of a base substrate, the dielectric layer is disposed on a side of the first metal layer away from the base substrate, and the second metal layer is disposed on a side of the dielectric layer away from the base substrate;
and wherein orthographic projections of the first metal layer, the dielectric layer, and the second metal layer on the base substrate overlap.

3. The display panel according to claim 1, wherein distances between adjacent rows of filtering polarization structures are equal, and distances between adjacent columns of filtering polarization structures are equal.

4. The display panel according to claim 2, wherein in the same filtering polarization structure, widths of the plurality of filtering polarization units are equal, and distances between adjacent filtering polarization units are equal.

5. The display panel according to claim 2, wherein a material of the first metal layer and the second metal layer comprises aluminum or silver;
and wherein a material of the dielectric layer comprises silicon oxide or zinc selenide.

6. The display panel according to claim 1, wherein the first substrate comprises a base substrate and a thin film transistor array;
wherein the plurality of filtering polarization structures are disposed on a side of the base substrate away from the thin film transistor array;
alternatively, the plurality of filtering polarization structures are disposed between the base substrate and the thin film transistor array;
alternatively, the plurality of filtering polarization structures are disposed on a side of the thin film transistor array away from the base substrate.

7. The display panel according to claim 1, further comprising a polarizer disposed on a side of the second substrate away from the first substrate;
wherein the polarizer is configured to transmit light having a second polarization direction; the first polarization direction is perpendicular or parallel to the second polarization direction.

8. The display panel according to claim 1, wherein the first substrate is an array substrate, and the second substrate is a color film substrate.

9. The display panel according to claim 8, wherein the color film substrate comprises a plurality of color filters arranged at intervals and arranged in an array; a black matrix layer is provided between adjacent color filters; the plurality of color filters correspond to the plurality of filtering polarization structures one-to-one; an orthographic projection of each filtering polarization structure on the color film substrate is located within an orthographic projection of a corresponding color filter on the color film substrate.

10. A display device, comprising: a backlight module and the display panel according to claim 1.

11. The display device according to claim 10, wherein the backlight module comprises a backlight source, a light guide plate, a diffusion sheet, and a prism sheet;
and wherein the backlight source is on a light entrance side of the light guide plate; the diffusion sheet is on a light exit side of the light guide plate, and the prism sheet is on a light exit side of the diffusion sheet and provides light to the display panel.

12. A method for manufacturing the display panel according to claim 1, comprising:
forming a first substrate, the first substrate comprising a plurality of sub-pixel regions arranged in an array;
forming a plurality of filtering polarization structures arranged in an array on the first substrate, the plurality of filtering polarization structures corresponding to the plurality of sub-pixel regions one-to-one; each filtering polarization structure being configured to transmit light having a first polarization direction and corresponding to a color of a sub-pixel region corresponding to the filtering polarization structure, and reflect light of other colors;
forming a second substrate; and
performing a cell aligning process on the first substrate and the second substrate.

13. The method according to claim 12, wherein forming the first substrate comprises:
providing a base substrate; and
forming a thin film transistor array on a side of the base substrate facing the second substrate.

14. The method according to claim 13, wherein forming the plurality of filtering polarization structures arranged in an array on the first substrate comprises:
forming a first metal layer on a side of the base substrate away from the thin film transistor array;
forming a dielectric layer on a side of the first metal layer away from the base substrate; and
forming a second metal layer on a side of the dielectric layer away from the base substrate.

15. The method according to claim 13, wherein forming the plurality of filtering polarization structures arranged in an array on the first substrate comprises:
forming a first metal layer on a side of the base substrate facing the thin film transistor array;
forming a dielectric layer on a side of the first metal layer away from the base substrate; and
forming a second metal layer on a side of the dielectric layer away from the base substrate.

16. The method according to claim 13, wherein forming the plurality of filtering polarization structures arranged in an array on the first substrate comprises:
forming a first metal layer on a side of the thin film transistor array away from the base substrate;
forming a dielectric layer on a side of the first metal layer away from the thin film transistor array; and
forming a second metal layer on a side of the dielectric layer away from the thin film transistor array.

17. The method according to claim 12, wherein forming the second substrate comprises:
providing a polarizer on a side of the second substrate away from the first substrate,
wherein the polarizer is configured to transmit light having a second polarization direction; the first polarization direction is perpendicular or parallel to the second polarization direction.

18. The method according to claim 12, wherein forming the second substrate comprises:
forming a plurality of color filters and a black matrix on a side of the second substrate facing the first substrate;
wherein the plurality of color filters correspond to the plurality of filtering polarization structures one-to-one; an orthographic projection of each filtering polarization structure on the second substrate is located within an orthographic projection of a corresponding color filter on the second substrate.

19. The display device according to claim 10, wherein each filtering polarization structure comprises: a plurality of filtering polarization units arranged at intervals;
wherein each filtering polarization unit comprises: a first metal layer, a second metal layer, and a dielectric layer;
wherein the first metal layer is disposed on a side of a base substrate, the dielectric layer is disposed on a side of the first metal layer away from the base substrate, and the second metal layer is disposed on a side of the dielectric layer away from the base substrate;
and wherein orthographic projections of the first metal layer, the dielectric layer, and the second metal layer on the base substrate overlap.

20. The display device according to claim 10, wherein distances between adjacent rows of filtering polarization structures are equal, and distances between adjacent columns of filtering polarization structures are equal.
